(19) United States
(12) Patent Application Publication
(10) Pub. No.: US 2019/0278472 A1
(43) Pub. Date: Sep. 12, 2019

(54) COMMUNICATION APPARATUS, COMMUNICATION METHOD, AND RECORDING MEDIUM

(71) Applicant: CANON KABUSHIKI KAISHA, Tokyo (JP)

(72) Inventor: Ichiro Tamura, Kawasaki-shi (JP)

(21) Appl. No.: 16/275,937

(22) Filed: Feb. 14, 2019

(30) Foreign Application Priority Data
Mar. 8, 2018 (JP) 2018-042445

(51) Int. Cl. G06F 3/0488; G06F 3/16; G06F 3/0482; G06F 3/14

(52) U.S. Cl. CPC G06F 3/04883; G06F 3/16; G06F 3/0486; G06F 3/1454; G06F 3/0482

(57) ABSTRACT

In a communication apparatus, in a case where an association representation associated with location information regarding a content is selected, before the content is displayed, whether playing the content and transmission of a screen displayed by or audio played by the communication apparatus is to be performed or transmission of location information of the content or the content to another communication apparatus is to be performed is selected based on a user operation.

### BACKGROUND

### Field of the Disclosure

The present disclosure relates to playing a content.

### Description of the Related Art

In recent years, there is a communication apparatus which can share, with another communication apparatus, a screen that the communication apparatus is displaying or audio that the communication apparatus is playing. A transmitting apparatus transmits, to a receiving apparatus, image data or audio data as information regarding a screen that the transmitting apparatus is displaying or audio that transmitting apparatus is playing so that the screen being displayed or audio being played can be shared between the transmitting apparatus and the receiving apparatus. This is called a mirroring function (which may be simply called “mirroring”).

Another kind of transmitting apparatus may transmit a content held by the transmitting apparatus to a receiving apparatus and cause the receiving apparatus to play the content. This is called a direct streaming function (which may be simply called “direct streaming”). In a case where a content is played by the direct streaming function, the transmitting apparatus may not play the content.

Another kind of transmitting apparatus may obtain a content from an external apparatus, which is not the transmitting apparatus, to a receiving apparatus and causes the receiving apparatus to play the content. This is called a content redirection function (which may be simply called “content redirection”). With the content redirection function, the transmitting apparatus transmits, to the receiving apparatus, location information regarding a content held by the external apparatus, and the receiving apparatus obtains and plays the content from the external apparatus based on the location information regarding the content.

Japanese Patent Laid-Open No. 2016-71638 discloses a communication apparatus which can play a content by using both of the mirroring function and the content redirection function where the content can be played by using one of the functions in accordance with an attribute of the content and a load state of the communication apparatus in a case where an operation for sharing a screen is performed.

In a communication apparatus which can play a content by using the mirroring function, a user may select an association representation associated with location information regarding the content displayed on a screen of the communication apparatus upon start of play of the content. The association representation associated with location information regarding a content may be a thumbnail or a play button linking with a URI of the content, for example. When a user of the communication apparatus selects the thumbnail or play button, a menu screen for controlling the play of the content is displayed or the content starts playing.

Even in a case where a communication apparatus supporting a plurality of playing methods for playing a content receives a selection of an association representation by a user, when one of the playing methods is selected based on an attribute of the content, the content may not possibly be played by the playing method desired by the user.

### SUMMARY

A communication apparatus according to an aspect of the present disclosure enables a content to be played by a playing method based on a user operation.

A communication apparatus includes a playing unit configured to play a content, a first transmitting unit configured to transmit at least one of image data based on a screen displayed by the communication apparatus and audio data based on audio played by the communication apparatus, a second transmitting unit configured to transmit location information of the content or the content to a first other communication apparatus for causing the first other communication apparatus to play the content, a display unit configured to display an association representation associated with the location information, and a selecting unit configured to select, based on a user operation, in a case where the association representation is selected by a user, before the content is displayed, whether play of the content by the playing unit and transmission by the first transmitting unit are to be performed or transmission by the second transmitting unit is to be performed.

Further features of various embodiments will become apparent from the following description of exemplary embodiments with reference to the attached drawings.

### BRIEF DESCRIPTION OF THE DRAWINGS

FIG. 1 illustrates a network structure of a network in which a communication apparatus participates.

FIG. 2 illustrates a hardware structure of the communication apparatus.

FIG. 3 is a flowchart illustrating processing to be executed when the communication apparatus and another communication apparatus perform mirroring.

FIG. 4 is a flowchart illustrating processing to be executed for playing a content by a playing method selected on a menu screen displayed based on a user operation input through the communication apparatus.

FIG. 5 is a flowchart illustrating processing to be executed for playing a content by a playing method based on a user operation input through the communication apparatus.

FIG. 6 is another flowchart illustrating processing to be executed for playing a content by a playing method based on a user operation input through the communication apparatus.

FIG. 7 illustrates an example of a screen presented based on a user operation performed on a thumbnail of a content on the communication apparatus.

FIG. 8 illustrates an example of a screen presented based on a user operation performed on a thumbnail of a content in a case where the communication apparatus detects a plurality of communication apparatuses.

FIG. 9 illustrates an example of a screen presented by the communication apparatus based on a user operation performed on a screen which is not associated with location information of the content.

### DESCRIPTION OF THE EMBODIMENTS

With reference to the attached drawings, embodiments will be described in detail below. The configurations in the following embodiments are given merely for illustration purposes, and some embodiments are not limited to the illustrated configurations.

### Embodiment 1

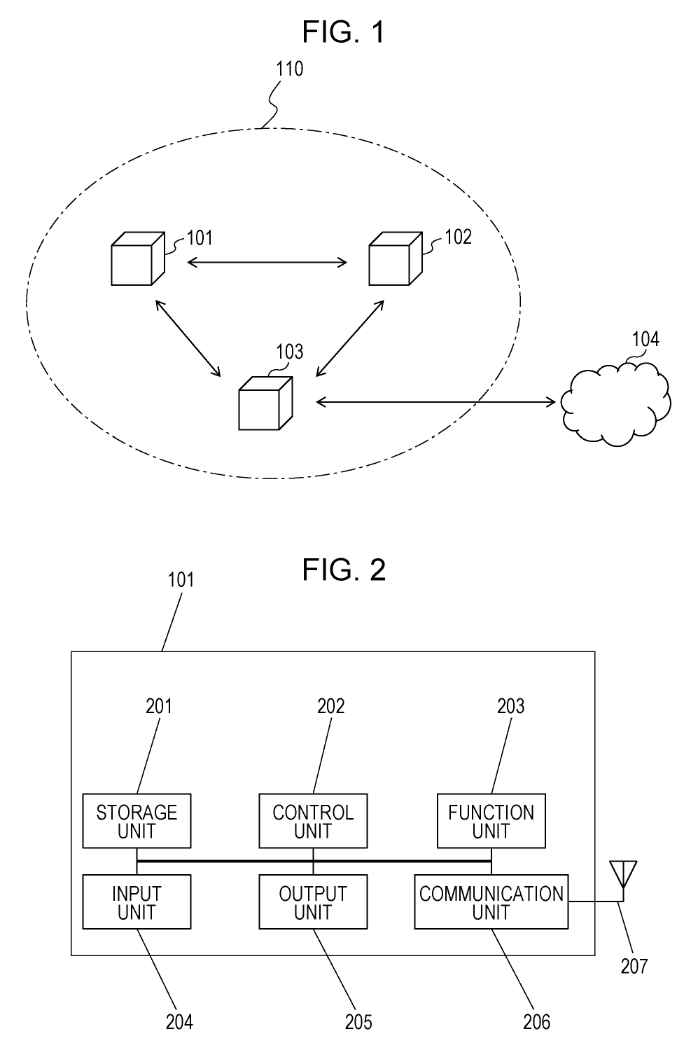

FIG. 1 illustrates a network configuration of a network in which a communication apparatus 101 according to Embodiment 1 participates. Over the network 110 illustrated in FIG. 1, apparatuses communicate with each other by a wireless communication method based on the IEEE 802.11 series standard. IEEE stands for Institute of Electrical and Electronics Engineers.

The communication apparatus 101 is configured to perform wireless communication based on the Wi-Fi Direct standard with a communication apparatus 102. In this case, the communication apparatus 101 and the communication apparatus 102 directly perform wireless communication without using an access point (AP) 103. The communication apparatus 101 can also perform wireless communication with the communication apparatus 102 via the AP 103 over an infrastructure network based on the IEEE 802.11 series standard.

Over the network 110, the apparatuses may perform wireless communication based on other wireless communication methods, such as Bluetooth®, NFC, UWB, ZigBee, and MBOA, as well as wireless communication based on the IEEE 802.11 series standard. UWB stands for Ultra Wide Band, and MBOA stands for Multi Band OFDM Alliance. OFDM stands for Orthogonal Frequency Division Multiplexing. NFC stands for Near Field Communication. UWB may include wireless USB, wireless 1394, WiNET, and so on. The apparatuses may perform communication based on a wired communication method, such as a wired LAN.

According to this embodiment, the communication apparatus 101 and the communication apparatus 102 perform mirroring based on the Wi-Fi Miracast standard. The communication apparatus 101 (transmitting apparatus) may be based on the Wi-Fi Miracast standard and shares screens displayed and audio played by the communication apparatus 101 with the communication apparatus 102 (receiving apparatus). More specifically, image data and audio data as information regarding a screen displayed by and audio played by the transmitting apparatus may be transmitted to the receiving apparatus over the network 110 so that the displayed screen and the played audio can be shared by the transmitting apparatus and the receiving apparatus. This is called mirroring. The communication apparatus 101, based on the Wi-Fi Miracast standard, may play a role of a source apparatus configured to transmit at least one of a screen displayed by and audio played by the communication apparatus 101. The communication apparatus 102, based on the Wi-Fi Miracast standard, may play a role of a sink apparatus configured to receive and play the screen or audio transmitted from the source apparatus. In a case where the communication apparatus 101 and the communication apparatus 102 perform mirroring, a screen displayed by or audio played by the communication apparatus 101 is shared by the communication apparatus 101 and the communication apparatus 102.

The communication apparatus 101 may perform mirroring over an infrastructure network as well as mirroring over a network based on the Wi-Fi Direct standard. The same is true in the communication apparatus 102.

A case will be described in which the communication apparatus 101 and the communication apparatus 102 perform mirroring over a network based on the Wi-Fi Direct standard. In this case, the communication apparatus 101 plays a role of the source apparatus, and the communication apparatus 102 plays a role of the sink apparatus. In mirroring over a network based on the Wi-Fi Direct standard, the source apparatus directly transmits (streams) to the sink apparatus over the network a stream of image data or audio data as information regarding a screen displayed by or audio played by the source apparatus. The image data may be acquired by encoding a screen being displayed by the source apparatus, and the audio data is acquired by encoding audio being played by the source apparatus. The sink apparatus then receives the stream of image data or audio data and plays it in synchronization with the source apparatus. In other words, the source apparatus and the sink apparatus which perform the mirroring share a displayed screen or played audio.

A case will be described in which the communication apparatus 101 (source apparatus) and the communication apparatus 102 (sink apparatus) perform mirroring over an infrastructure network. In the mirroring over an infrastructure network, the source apparatus transmits a stream of an image data or audio data to the sink apparatus via the AP 103. The sink apparatus receives the stream of image data or audio data via the AP 103 and plays it in synchronization with the source apparatus.

The communication apparatus 101 and the communication apparatus 102 may further perform content redirection over a network based on the Wi-Fi Direct standard or over an infrastructure network as well as the mirroring. In the content redirection, the communication apparatus 101 causes the communication apparatus 102 to obtain data from an external apparatus other than the communication apparatus 101 and causes the communication apparatus 102 to play the data. Here, the external apparatus may be a cloud server 104. In this case, the communication apparatus 101 transmits to the communication apparatus 102 information for obtaining data from the external apparatus. The data to be obtained by the communication apparatus 102 may be a content, for example, such as image data, audio data, moving picture data, video data, or document data. The video data are data including both of audio data and moving picture data. In addition, the content may be at least one of software data, GUI data, and metadata for playing the data as described above.

The information to be transmitted from the communication apparatus 101 to the communication apparatus 102 is association information regarding a content on an external apparatus. The association information regarding a content may be information such as an identifier for identifying the content on an external apparatus, a service name, location information (URI) regarding the content, and a play start time (offset). The association information regarding a content to be received may be a part of the information as described above. The identifier of a content is an identifier for uniquely identifying the content. The location information regarding a content is information regarding a storage area which stores the content. URI stands for Uniform Resource Identifier and may include one or both of a URL and a URN. URL stands for Uniform Resource Locator, and URN stands for Uniform Resource Name.

Specific examples of the communication apparatus 101 include a tablet, a smart phone, a PC, a cellular phone, a camera, and a video camera, but the communication apparatus 101 is not limited thereto. The communication apparatus 101 is configured to transmit the association information regarding a content held in an external apparatus to another communication apparatus so that the other communication apparatus is caused to obtain and play the content.

Specific examples of the communication apparatus 102 include a tablet, a smart phone, a PC, a cellular phone, a television set, a television adapter, a set top box, and a head-mounted display. Other specific examples of the communication apparatus 102 include a projector, a display, and a car navigation apparatus. However, the communication apparatus 102 is not limited to these examples. The communication apparatus 102 may be configured to obtain and play a content from an external apparatus based on association information received from the communication apparatus 101.

The communication apparatus 101 and the communication apparatus 102 may perform direct streaming over a network based on the Wi-Fi Direct standard or an infrastructure network as well as content redirection. In direct streaming, the communication apparatus 101 transmits data stored in the communication apparatus 101 to the communication apparatus 102, and the communication apparatus 102 receives and plays the data. In this case, the communication apparatus 101 can transmit the data to the communication apparatus 102 by using encoded data (e.g., data encoded according to an encoding scheme) as it is without decoding and re-encoding. Here, the data to be received by the communication apparatus 102 may be a content, for example.

Referring to FIG. 1, the Wi-Fi Miracast standard is used as a communication scheme by the communication apparatus 101 for performing mirroring. However, the communication scheme is not limited to the Wi-Fi Miracast standard, but other communication schemes, such as WiDi and Wireless HD, may be used. WiDi stands for Intel Wireless Display, and Wireless HD stands for Wireless High Definition. More specifically, the communication scheme may support wireless communication corresponding to at least one of mirroring, content redirection, and direct screaming. According to Wi-Fi Miracast standard, the communication apparatus 101 performs mirroring over a network or an infrastructure network based on the Wi-Fi Direct standard. Over such a network, the communication apparatus 101 can establish an ASP session with the communication apparatus 102 that is the other mirroring partner so that the communication apparatuses 101 and 102 can perform mirroring through the established ASP session. ASP stands for Application Service Platform. The communication apparatus 101 may use different wireless communication methods for mirroring and for content redirection.

FIG. 2 illustrates a hardware configuration of the communication apparatus 101.

The communication apparatus 101 includes a storage unit 201, a control unit 202, a function unit 203, an input unit 204, an output unit 205, a communication unit 206, and an antenna 207.

The storage unit 201 includes one or more memories, such as a ROM and a RAM, and is configured to store computer programs for performing operations, which will be described below, and information, such as communication parameters for wireless communication. ROM stands for Read Only Memory, and RAM stands for Random Access Memory. The storage unit 201 may include, in addition to the memories such as the ROM and the RAM, a storage medium, such as a flexible disk, a hard disk, an optical disk, a magneto-optical disk, a CD-ROM, a CD-R, a magnetic tape, a nonvolatile memory card, and a DVD. The storage unit 201 may include a plurality of memories.

The control unit 202 includes one or more processors, such as a CPU and an MPU, and is configured to execute a computer program stored in the storage unit 201 to control the communication apparatus 101 overall. CPU stands for Central Processing Unit, and MPU stands for Micro Processing Unit. The control unit 202 may control the communication apparatus 101 overall in cooperation with the computer programs and an OS (Operating System) stored in the storage unit 201. Alternatively, the control unit 202 may include a plurality of processors, such as multi-core processors, and may employ the plurality of processors to control the communication apparatus 101 overall.

The control unit 202 may execute a computer program stored in the storage unit 201 to implement one or both of the mirroring function and the content redirection function as a source apparatus. The mirroring function as a source apparatus is a function which transmits image data or audio data to a sink apparatus. In this case, the image data is acquired by capturing and encoding a screen displayed by the source apparatus, and the audio data is acquired by encoding audio played by the source apparatus. The content redirection function as a source apparatus is a function to transmit information to a sink apparatus. In this case, the information is to be used by the sink apparatus for obtaining a content to be played by the sink apparatus from an external apparatus other than the source apparatus. With content redirection function as a source apparatus, the content communication apparatus 101 can transmit a play control signal for controlling play of a content in the sink apparatus to the sink apparatus. The control unit 202 may execute a computer program stored in the storage unit 201 so that the communication apparatus 101 implements the direct streaming function as a source apparatus. The direct streaming function as a source apparatus is a function to transmit a content stored in the storage unit 201 to a sink apparatus.

The control unit 202 may control the function unit 203 to execute a predetermined process, such as image capturing and content browsing. The function unit 203 is a hardware module to be used by the communication apparatus 101 for executing a predetermined process. For example, in a case where the communication apparatus 101 is a camera, the function unit 203 corresponds to an image capturing unit to perform image capturing processing. In the communication apparatus 101, data generated by the image capturing unit is displayed on a screen of the output unit 205, which will be described below, and is transmitted to another communication apparatus by the mirroring function of the control unit 202 to execute mirroring. Alternatively, data stored in the storage unit 201 in the communication apparatus 101 is displayed on a screen of the output unit 205 to execute mirroring.

The input unit 204 is configured to receive an operation from a user. The output unit 205 is configured to output to a user through a monitor screen or a speaker. In this case, the outputting of the output unit 205 may include displaying on a screen, outputting audio by a speaker, and outputting vibrations. The monitor screen to be output by the output unit 205 is a screen displayed on a monitor included in the communication apparatus 101. Alternatively, it may be a screen on a monitor in another apparatus connected to the communication apparatus 101. Both of the input unit 204 and the output unit 205 may be implemented by one module, such as a touch panel. Each of the input unit 204 and the output unit 205 may be provided separately from the communication apparatus 101.

The communication unit 206 is configured to control wireless communication based on the IEEE 802.11 series, control wired communication with a wired LAN, for example, and control IP (Internet Protocol) communication. The communication unit 206 is further configured to control the antenna 207 to transmit and receive a wireless signal for wireless communication. The communication apparatus 101 communicates a content, such as image data, document data, and video data, with the communication apparatus 102 through the communication unit 206.

The communication apparatus 102 may have the same hardware configuration as that of the communication apparatus 101. Because the storage unit 201, the function unit 203, the input unit 204, the output unit 205, the communication unit 206, and the antenna 207 in the communication apparatus 102 may be the same as those in the communication apparatus 101, any repetitive description will be omitted. The control unit 202 is similar to the control unit 202 in the communication apparatus 101, but differences will be briefly described.

The control unit 202 in the communication apparatus 102 is configured to execute a computer program stored in the storage unit 201 to implement the mirroring function and the content redirection function as a sink apparatus. The mirroring function as a sink apparatus is a function which receives, decodes, and plays image data or audio data. In this case, the image data is acquired by capturing and encoding a screen displayed by the source apparatus, and the audio data is acquired by encoding audio played by the source apparatus. The content redirection function as a sink apparatus is a function to obtain a content to play from an external apparatus other than the source apparatus based on information transmitted from the source apparatus and to play the content. With the content redirection function as a sink apparatus, the communication apparatus 102 can control play of a content performed by the communication apparatus 102 based on play control information received from the source apparatus. The control unit 202 in the communication apparatus 102 may execute a computer program stored in the storage unit 201 so that communication apparatus 102 implements the direct streaming function as a sink apparatus. The direct streaming function as a sink apparatus is a function to receive and play a content transmitted from the source apparatus.

The communication apparatus 101 and communication apparatus 102 can display an image and play audio. However, each of the communication apparatus 101 and the communication apparatus 102 can either display an image or play audio.

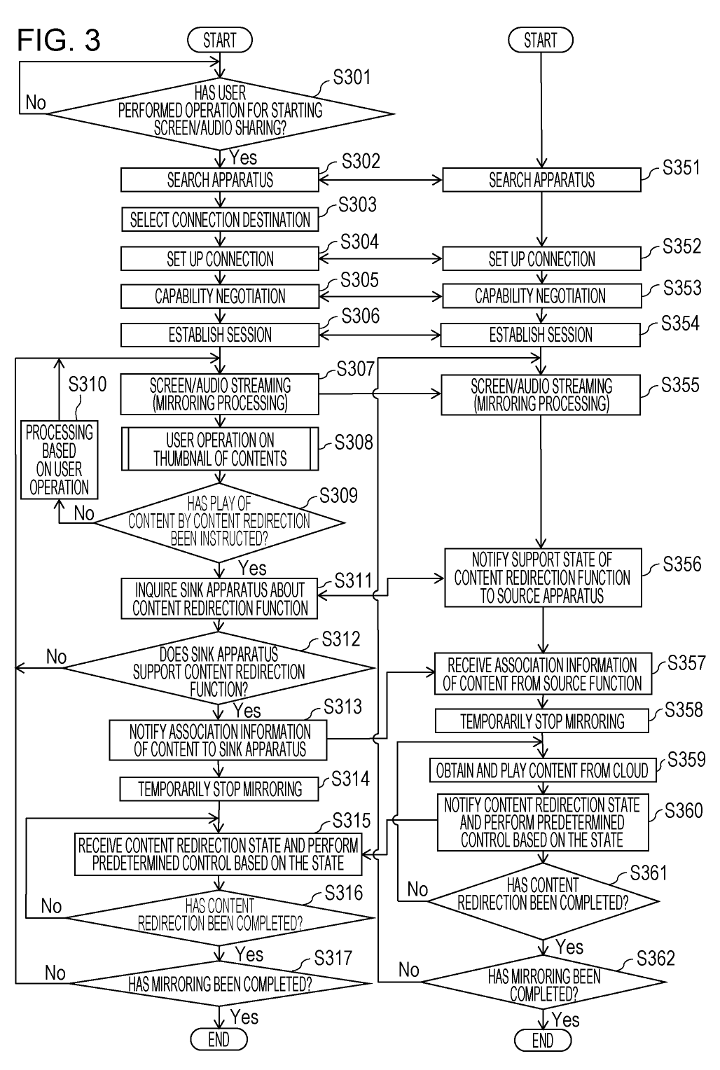

FIG. 3 is a flowchart illustrating processing to be executed when the communication apparatus 101 and the communication apparatus 102 perform mirroring. Processing from S301 to S317 may be implemented by a computer program stored in the storage unit 201 and read out and executed by the control unit 202 in order for the communication apparatus 101 to perform content redirection. The processing from S351 to S362 may be implemented by a computer program stored in the storage unit 201 and read out and executed by the control unit 202 in order for the communication apparatus 102 to perform content redirection.

At least a part of the flowchart illustrated in FIG. 3 may be implemented by hardware. In a case where at least a part of the flowchart is implemented by hardware, a predetermined compiler, for example, may be used to automatically generate dedicated circuits on an FPGA from the computer program implementing the operations. FPGA stands for Field Programmable Gate Array. The processing may be implemented by hardware by forming Gate Array circuits in the same manner as that on the FPGA. Alternatively, the processing may be implemented by an ASIC (Application Specific Integrated Circuit).

S301 of the flowchart is started with powering on of the communication apparatus 101. Also, S301 in the flowchart may be started with the starting of a predetermined application in the communication apparatus 101. S351 in the flowchart is started with powering on of the communication apparatus 102. Also, S351 in the flowchart may be started with the starting of a predetermined application in the communication apparatus 102.

First, the control unit 202 in the communication apparatus 101 determines whether an operation for starting screen/audio sharing has been performed by a user through the input unit 204 (S301). The operation for starting screen/audio sharing includes pressing down of a control button for starting screen/audio sharing by a user. Without limiting thereto, the control unit 202 in the communication apparatus 101 may receive a user operation, such as a predetermined keyboard operation, a mouse operation, a touch operation, and a joystick operation, for the start operation. The control unit 202 in the communication apparatus 101 may perform the start operation in response to a user operation, such as a predetermined gesture, pressing down of a control button on a remote controller, start of play of a predetermined content, or start of a predetermined application. If it is determined that the start operation for screen/audio sharing has not been performed (No in S301), the control unit 202 in the communication apparatus 101 performs the processing in S301 again. If, on the other hand, it is determined that the start operation for screen/audio sharing has been performed (Yes in S301), the control unit 202 in communication apparatus 101 performs processing in S302.

Next, an apparatus search is performed between the communication apparatus 101 and the communication apparatus 102. The communication apparatus 101 and the communication apparatus 102 search for an apparatus to perform mirroring through wireless communication based on the Wi-Fi Direct standard (or other wireless connection that does not require an access point). Alternatively, the communication apparatus 101 and the communication apparatus 102 may search for an apparatus to perform mirroring over an infrastructure network.

In this embodiment, the communication apparatus 101 and the communication apparatus 102 search for an apparatus to perform mirroring through wireless communication based on the Wi-Fi Direct standard (S302, S351). More specifically, the control unit 202 in the communication apparatus 101 first transmits a Probe Request based on the IEEE 802.11 series standard as an apparatus discovery request, and the control unit 202 in the communication apparatus 102 responds with a Probe Response. Thus, the communication apparatus 101 and the communication apparatus 102 find each other. The apparatuses to transmit Probe Request/Response may be interchanged.

The control unit 202 in the communication apparatus 101 displays a list of discovered apparatuses on a monitor screen of the output unit 205. A user may select an apparatus with which screen/audio sharing is to be performed from the list of apparatuses displayed on the monitor screen of the communication apparatus 101. The control unit 202 in the communication apparatus 101 selects the apparatus selected by a user as a connection partner apparatus with which screen/audio sharing is to be performed (S303). It should be noted that the selection of a connection partner apparatus in this operation may be performed by the communication apparatus 101 based on logs of an apparatus which has performed screen/audio sharing in the past, if any. More specifically, in a case where there is an apparatus with which screen/audio sharing has been performed in the past in the detected apparatuses, the control unit 202 in the communication apparatus 101 selects the apparatus as a connection partner apparatus. Alternatively, the control unit 202 in the communication apparatus 101 may select, as a connection partner apparatus, an apparatus closest in distance to the communication apparatus 101 or an apparatus with the highest communication quality. The selection of the connection partner apparatus in S303 may be performed by the communication apparatus 102.

This embodiments applies Probe Request/Response for the apparatus search, but a wireless signal by using a Beacon based on the IEEE 802.11 series standard may be applied according to the Wi-Fi Miracast standard. The communication apparatus 101 or the communication apparatus 102 may apply an NFC, a QR Code®, Bluetooth low energy (BLE), or the like for the apparatus search. For example, when the communication apparatus 101 has an NFC communication function, an NFC touch operation is performed for pairing of the communication apparatus 101 and the communication apparatus 102, and the subsequent communications may be performed based on the Wi-Fi Miracast standard.

In this case, before the processing in S304 and S352 is performed, the communication apparatus 101 and the communication apparatus 102 may perform a service search. The service search may be performed based on the Wi-Fi Direct standard, and through the service search, at least one of the communication apparatus 101 and the communication apparatus 102 can obtain information regarding a service provided by the partner apparatus.

Next, the control unit 202 in the communication apparatus 101 sets up a connection with the connection partner apparatus selected in S303 (S304). It is assumed here that, in S303, the communication apparatus 102 is selected as the connection partner apparatus. Then, the control unit 202 in the communication apparatus 102 also sets up a connection with the communication apparatus 101 (S352). More specifically, the communication apparatus 101 and the communication apparatus 102 perform Wi-Fi Miracast connection processing and then perform TCP connection processing. By performing these kinds of connection processing, a connection set-up completes between the communication apparatus 101 and the communication apparatus 102. TCP stands for Transmission Control Protocol.

The communication apparatus 101 and the communication apparatus 102 perform the Wi-Fi Miracast connection processing based on Wi-Fi Direct standard according to this embodiment, though either the Wi-Fi Direct standard or the TDLS standard is selectable. TDLS stands for Tunneled Direct Link Setup.

Next, detail procedures of S304 and S352 will be described. First, the communication apparatus 102 transmits a Probe Request to the communication apparatus 101. The communication apparatus 101 having received the Probe Request transmits a Probe Response to the communication apparatus 102. Thus, the communication apparatus 101 and the communication apparatus 102 recognize the partner apparatus with each other. Next, in order to determine a communication apparatus to be a Group Owner (GO) which establishes a network in a wireless communication based on the Wi-Fi Direct standard, the communication apparatus 101 transmits a GO Negotiation Request. This signal contains an Intent value which indicates the degree to be the GO of the communication apparatus 101. The communication apparatus which is not the GO is a Client (CL) and participates in a network established by the GO.

The communication apparatus 102 having received the GO Negotiation Request transmits a GO Negotiation Response containing an Intent value of the communication apparatus 102 in response thereto. The communication apparatus 101 having received the GO Negotiation Response compares the magnitudes of the Intent values of the communication apparatus 101 and the communication apparatus 102, and the communication apparatus with the higher Intent value is determined as the GO. On the other hand, the communication apparatus having a lower Intent value is determined as the CL.

The communication apparatus 101 transmits a GO Negotiation Confirm containing the result of the comparison of the Intent values to the communication apparatus 102. According to this embodiment, because the Intent value of the communication apparatus 101 is higher than the Intent value of the communication apparatus 102, the communication apparatus 101 is determined as the GO, and the communication apparatus 102 is determined as the CL.

After that, a WPS scheme is used to share parameter information, such as information regarding connection and security, for a network connection between the communication apparatus 101 and the communication apparatus 102. WPS stands for Wi-Fi Protected Setup. Based on the exchanged parameter information, the communication apparatus 102 acting as the CL transmits an Association Request to the communication apparatus 101 acting as the GO. The communication apparatus 101 having received the signal transmits an Association Response in response thereto.

Thus, the Wi-Fi Miracast connection processing based on the Wi-Fi Direct standard is completed between the communication apparatus 101 and the communication apparatus 102. According to this embodiment, the communication apparatus 101 is the GO, and the communication apparatus 102 is the CL, but they may be interchanged. Wireless signals transmitted by the GO may be transmitted by the CL. In this case, wireless signals transmitted by the CL may be transmitted by the GO. For the Wi-Fi Miracast connection processing, the communication apparatus 101 and the communication apparatus 102 may use a Beacon, a Reassociation message, or the like instead of the wireless signals. Alternatively, the communication apparatus 101 and the communication apparatus 102 may use a P2P Invitation message, a Provision Discovery message, or the like.

Then, a TCP connection is established between the communication apparatus 101 and the communication apparatus 102. This connection is established by a Three-way handshake where the communication apparatus 101 plays a role of a TCP server and the communication apparatus 102 plays a role of a TCP client.

The Wi-Fi Miracast connection processing completes between the communication apparatus 101 and the communication apparatus 102 to establish a TCP connection. Thus, the connection set-up completes.

In a case where the communication apparatus 101 and the communication apparatus 102 search for an apparatus with which mirroring is performed over an infrastructure network, the processing from S302 to S304, in S351, and in S352 is performed in the manner which will be described below.

An apparatus with which mirroring is performed over an infrastructure network is searched through multicast DNS (or mDNS). DNS stands for Domain Name System. First, a DNS packet is multicasted to other communication apparatuses participating in the infrastructure network via the AP 103 to which the communication apparatus 101 is connected. The communication apparatus 101 receives a response from an apparatus which can perform mirroring via the AP 103 so that the communication apparatus 101 detects the apparatus. More specifically, the communication apparatus 101 transmits a DNS packet including a DNS record via the AP 103. For the search, the DNS record indicates that the communication apparatus 101 designates a communication apparatus supporting wireless communication based on the Wi-Fi Miracast standard. The DNS record contains one service name of Displaysrc indicating a source apparatus and Display indicating a sink apparatus. The communication apparatus 101 searches a sink apparatus as an apparatus with which mirroring is to be performed. Therefore, the DNS record includes Display indicating a sink apparatus. The communication apparatus 101 may transmit a DNS packet an arbitrary number of times at arbitrary transmission intervals. It is assumed here that, for searching an apparatus, the communication apparatus 101 repeats the transmission of the DNS packet up to a predetermined number of times. Alternatively, the communication apparatus 101 repeats the transmission of the DNS packet until passage of a predetermined time period. The communication apparatus 101 may stop the transmission of the DNS packet when the communication apparatus 101 receives a response from a predetermined number of applicable apparatuses.

When the control unit 202 in the communication apparatus 101 searches for an apparatus with which mirroring is to be performed over the infrastructure network, a search result thereof is displayed, and a connection partner apparatus is selected. The displaying of a search result and selecting of a connection partner apparatus are performed in the same manner as that in S303.

Next, the control unit 202 in the communication apparatus 101 transmits an mDNS inquiry via the AP 103 to the selected connection partner apparatus (here, the communication apparatus 102). The mDNS inquiry to be transmitted here is a signal inquiring capability information regarding the communication apparatus 102 and a port number and a host name to be used for communication between the communication apparatus 101 and the communication apparatus 102. The capability information regarding the communication apparatus 102 inquired by the mDNS inquiry is information indicating whether the communication apparatus 102 is a sink apparatus, a source apparatus, or a dual-role apparatus. The communication apparatus 102 having received the mDNS inquiry transmits an mDNS response including the capability information of the communication apparatus 102, the port number, and the host name to the communication apparatus 101. The communication apparatus 101 having received the response completes the connection setup with the communication apparatus 102.

The same processing is performed after the communication apparatus 101 and the communication apparatus 102 complete their connection set up for mirroring over a network based on the Wi-Fi Direct standard and for mirroring over an infrastructure network.

Next, the control unit 202 in the communication apparatus 101 performs Capability Negotiation (S305). The control unit 202 in the communication apparatus 102 also performs Capability Negotiation (S353). The Wi-Fi Miracast standard provides that RTSP (Real Time Streaming Protocol) is to be applied for Capability Negotiation. The RTSP is a protocol for controlling streaming. Typically, TCP is applied as a lower layer transport protocol. For Capability Negotiation, predetermined messages RTSP M1 to M4 are exchanged between the communication apparatus 101 and the communication apparatus 102. The communication apparatus 101 can obtain the capability information regarding the communication apparatus 102 by exchanging the RTSP messages, determine parameters to be used, and notify them to the communication apparatus 102. The communication apparatus 102 sets the parameters notified from the communication apparatus 101. Examples of the capability information relating to a screen may include a resolution and a frame rate of a screen supported by the communication apparatus 102. Examples of the capability information relating to audio may include information regarding codec and a sampling frequency supported by the communication apparatus 102. As a result of Capability Negotiation, monitors to be used for mirroring, the type of audio encoding method, and video resolution and frame rate are determined between the communication apparatus 101 and the communication apparatus 102. The capability information to be exchanged between the communication apparatus 101 and the communication apparatus 102 may be a part of those pieces of information.

After the Capability Negotiation completes, the control unit 202 in the communication apparatus 101 and the control unit 202 in the communication apparatus 102 establish a session based on the Wi-Fi Miracast standard (S306, S354). According to the Wi-Fi Miracast standard, for the session establishment, predetermined messages RTSP M5 to M7 are exchanged between the communication apparatus 101 and the communication apparatus 102. Through the exchange of the RTSP messages, the port number is set to establish a session between the communication apparatus 101 and the communication apparatus 102.

After the session is established, the control unit 202 in the communication apparatus 101 starts mirroring processing as a source apparatus and starts transmitting a video/audio stream (S307). In this operation, the control unit 202 in the communication apparatus 101 performs mirroring processing as a source apparatus, including capturing a displayed screen, encoding the captured image, multiplexing, and data transmission processing. The mirroring processing to be performed by the communication apparatus 101 may include a part of the processing.

The control unit 202 in the communication apparatus 102 starts mirroring processing as a sink apparatus and starts receiving a video/audio stream (S355). In this operation, the control unit 202 in the communication apparatus 102 performs mirroring processing as a sink apparatus, including data reception, reverse multiplexing, decoding of a captured image, and playing of the decoded captured image. The mirroring processing to be performed by the communication apparatus 102 may be a part of the processing.

Through the processing in S307 and S355 by the communication apparatus 101 and the communication apparatus 102, streams of information of screens displayed by and audio played by the communication apparatus 101 are transmitted to the communication apparatus 102. The communication apparatus 102 plays the received streams of information of screens or audio so that the same screens can be displayed or the same audio can be played as that of the communication apparatus 101.

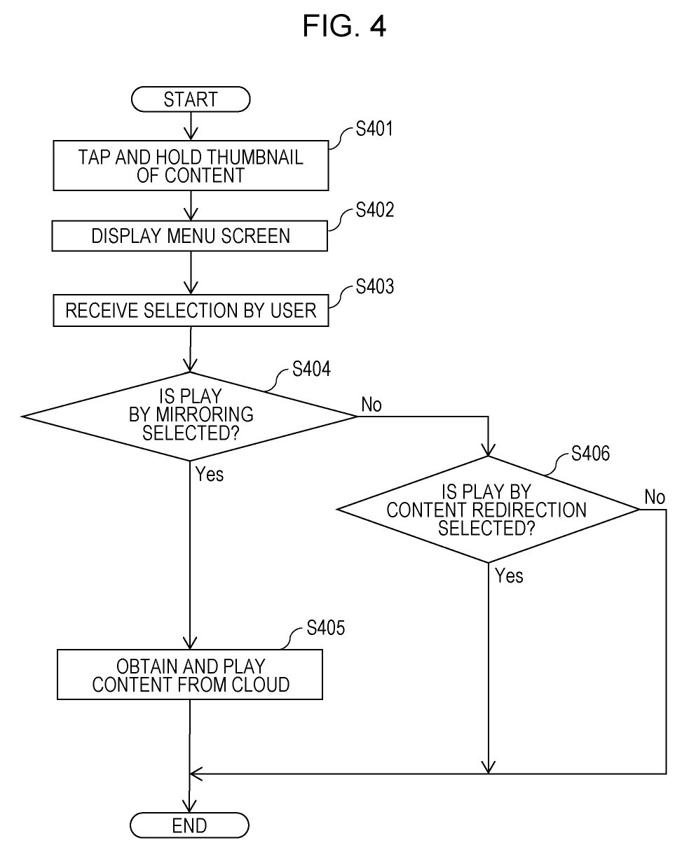

Next, the control unit 202 in the communication apparatus 101 receives a user operation which instructs to play a content (S308). In this operation, as the user operation which instructs to play a content, the communication apparatus 101 receives a user operation performed on a thumbnail of the content. The thumbnail of a content is associated with a URI of the content. The URI of a content is information including location information regarding the content. The communication apparatus 101 may receive a user operation performed on an association representation that is an image or a character string associated with a URI of a content, such as a hyperlink, an icon, or a play button, instead of a thumbnail of the content. A play button for a content is a software key displayed on a screen on the communication apparatus 101 and is associated with a URI of the content. When the play button is selected by a user, the communication apparatus 101 obtains and plays the content based on the URI of the associated content. The control unit 202 in the communication apparatus 101 determines whether the content are to be played by mirroring or by content redirection based on a user operation performed on the thumbnail of the content. Details of this operations will be described below with reference to FIGS. 4 to 6.

The control unit 202 in the communication apparatus 101 determines whether it is instructed to play the content by content redirection based on the user operation received in S308 (S309). If the control unit 202 in the communication apparatus 101 determines that it is not instructed to play the content by content redirection (No in S309), the processing in S310 is performed. On the other hand, if the control unit 202 in the communication apparatus 101 determines that it is instructed to play the content by content redirection (Yes in S309), processing in S311 is performed.

The control unit 202 in the communication apparatus 101 performs processing based on the user operation received in S308 (S310). For example, if the instruction to play the content by mirroring is received in S308, the control unit 202 in the communication apparatus 101 obtains and starts playing the content from the cloud server 104 in S308. In this operation, the control unit 202 in the communication apparatus 101 continues the obtaining and playing of the content from the cloud server 104. For example, if it is instructed in S308 to copy text or an image, the control unit 202 in communication apparatus 101 copies the corresponding text or image. When the control unit 202 in the communication apparatus 101 performs the processing based on the user operation received in S308, the control unit 202 performs the processing in S307 and continues the mirroring.

On the other hand, if the control unit 202 in the communication apparatus 101 determines that it is instructed to play the content by content redirection (Yes in S309), processing in S311 is performed.

The control unit 202 in the communication apparatus 101 inquires of the communication apparatus 102 about whether the communication apparatus 102 supports a content redirection function (S311). The control unit 202 in the communication apparatus 101 may use an RTSP GET_PARAMETER message for the inquiry about the support of the content redirection function. The control unit 202 in the communication apparatus 102 having received the inquiry responds with the supportability of the content redirection function to the communication apparatus 101 (S356). The control unit 202 in the communication apparatus 102 may respond with information regarding a content having a service name with which the content can be played by the content redirection function by the communication apparatus 102.

The control unit 202 in the communication apparatus 101 determines whether the communication apparatus 102 supports the content redirection function based on the response received in S311 (S312). If the control unit 202 in the communication apparatus 101 determines that the communication apparatus 102 does not support the content redirection function (No in S312), then the processing in S307 is performed. In this case, at least one of the communication apparatus 101 and the communication apparatus 102 may notify a user of that the communication apparatus 102 does not support the content redirection function. On the other hand, if the control unit 202 in the communication apparatus 101 determines that the communication apparatus 102 supports the content redirection function (Yes in S312), the control unit 202 transmits association information regarding the content to the communication apparatus 102 (S313). The transmission of the association information regarding the content by the control unit 202 in the communication apparatus 101 requests the communication apparatus 102 to obtain and play the content. In this case, the association information regarding the content to be transmitted by the communication apparatus 101 may be information such as an identifier for identifying the content on the cloud server 104, a service name, content location information (e.g., a URI), a play start time (offset), and so on. A part of the association information regarding the content may be transmitted by the communication apparatus 101. An RTSP SET_PARAMETER message may be used for the transmission of association information regarding the content by the control unit 202 in the communication apparatus 101.

The control unit 202 in the communication apparatus 102 receives the association information regarding the content from the communication apparatus 101 (S357). If the control unit 202 in the communication apparatus 102 receives the association information regarding the content, the control unit 202 temporarily stops the mirroring processing that is being executed (S314). The control unit 202 in the communication apparatus 101 also temporarily stops the mirroring process that is being executed (S358). The control unit 202 in the communication apparatus 101 and the control unit 202 in the communication apparatus 102 temporarily stop the mirroring processing in response to the message exchange that is transmission and reception of the association information regarding the content performed in S313 and S357. Alternatively, the control unit 202 in the communication apparatus 101 having performed the processing in S313 may temporarily stop the mirroring processing performed in the communication apparatus 101 and may transmit a wireless signal to instruct the mirroring processing to the communication apparatus 102 to temporarily stop. Also, the control unit 202 in the communication apparatus 102 having performed the processing in S357 may temporarily stop the mirroring processing in the communication apparatus 102 and may transmit a wireless signal to instruct the communication apparatus 101 to temporarily stop the mirroring processing. In a case where content redirection is performed while mirroring is being executed, the mirroring processing may be temporarily stopped. Thus, process loads of the mirroring imposed on the communication apparatus 101 and the communication apparatus 102 can be reduced, and the power consumption can also be reduced.

When the control unit 202 in the communication apparatus 102 temporarily stops the mirroring processing, the content is obtained and are played from the cloud server 104 based on the association information regarding the content received in S357 (S359). In this embodiment, the communication apparatus 102 receives the content from the cloud server 104 via the AP 103. The method and protocol for receiving a content by the control unit 202 in the communication apparatus 101 may vary in accordance with the type of the content or the type of the service. For example, the control unit 202 in the communication apparatus 101 may receive the content by using an HLS scheme or an HTTP GET method. Here, HLS stands for HTTP Live Streaming, and HTTP stands for Hyper Text Transfer Protocol.

The control unit 202 in the communication apparatus 102 having started receiving and playing the content by content redirection detects a state of the content redirection and notifies the state to the communication apparatus 101 (S360). The control unit 202 in the communication apparatus 101 receives the notification of the state of the content redirection from the communication apparatus 102 (S315). In S360 and S315, the control unit 202 in the communication apparatus 102 and the control unit 202 in the communication apparatus 101 perform predetermined controls based on the state of the content redirection. For example, when the control unit 202 in the communication apparatus 102 detects that the content have played to the end and notifies it to the communication apparatus 101, the communication apparatus 101 and the communication apparatus 102 restart the temporarily stopped mirroring. Alternatively, the communication apparatus 101 and the communication apparatus 102 may stop communicating over the network based on the Wi-Fi Direct standard or communicating over the infrastructure network. In a case where the content to be played after the content which has been played to the end is determined, the communication apparatus 101 may transmit association information regarding the content to be played after to the communication apparatus 102. The communication apparatus 102 having received the association information regarding the content to be played after obtains and plays the content based on the received association information.

Next, the control unit 202 in the communication apparatus 101 and the control unit 202 in the communication apparatus 102 determine whether the content redirection has been completed (S316, S361). The content redirection can be completed in S315 and S360. If the control unit 202 in the communication apparatus 101 determines that the content redirection has not been completed (No in S316), the processing in S315 is performed again. On the other hand, if it is determined that the content redirection has been completed (Yes in S316), the control unit 202 in the communication apparatus 101 performs the processing in S317. If the control unit 202 in the communication apparatus 102 determines that the content redirection has not been completed (No in S361), the processing in S359 is performed again. On the other hand, if it is determined that the content redirection has been completed (Yes in S361), the control unit 202 in the communication apparatus 102 performs the processing in S362.

Each of the control unit 202 in the communication apparatus 101 and the control unit 202 in the communication apparatus 102 determines whether the mirroring has been completed (S317, S362). The mirroring can be completed in S315 and S360. Each of the control unit 202 in the communication apparatus 101 and the control unit 202 in the communication apparatus 102 may complete the mirroring in each of the operations after the S307 and S355.

If it is determined that the mirroring has been completed (Yes in S317), the control unit 202 in the communication apparatus 101 ends the processing in the flowchart illustrated in FIG. 3. Also, if the control unit 202 in the communication apparatus 102 determines that the mirroring has been completed (Yes in S362), the processing in the flowchart illustrated in FIG. 3 ends. On the other hand, if it is determined that the mirroring has not been completed (No in S317), the control unit 202 in the communication apparatus 101 performs the processing in S307, where the temporarily stopped mirroring processing is restarted. If it is determined that the mirroring has not been completed (No in S362), the control unit 202 in the communication apparatus 102 performs the processing in S355, where the temporarily stopped mirroring processing is restarted.

The flowchart in FIG. 3 illustrates the processing to be executed when the communication apparatus 101 and the communication apparatus 102 perform content redirection.

In order to perform content redirection, mirroring is started before the content redirection is performed in FIG. 3. However, some embodiments are not limited thereto. The communication apparatus 101 and communication apparatus 102 may start the content redirection without starting mirroring after a session is established in S306 and S354. More specifically, the communication apparatus 101 starts the flowchart with the processing in S308 and then with the determination in S309. If “Yes” is determined as a result of the determination in S309, the control unit 202 in the communication apparatus 101 performs the processing from S302 to the S306. On the other hand, if “No” is determined, the control unit 202 in the communication apparatus 101 performs the processing in S310, and the processing in S308 is performed again. In a case where it is instructed in S308 to play the content by mirroring, the control unit 202 in the communication apparatus 101 in S308 performs the processing from S302 to S307 and the content play by the mirroring is then performed. The communication apparatus 102 performs processing from S351 to S354 when the communication apparatus 101 performs the processing from S302 to S306. After the communication apparatus 101 establishes a session in S306, the communication apparatus 101 performs the processing in S311. After the communication apparatus 102 establishes the session in S354, the communication apparatus 102 performs the processing in S356. In this case, the processing in S314 and S358 is omitted. The determinations in S317 and S362 are also omitted.

In this flowchart, the communication apparatus 101 controls to play a content by mirroring or content redirection based on a user operation performed on the thumbnail of the content.

FIG. 4 is a flowchart illustrating processing to be executed when a menu screen is displayed based on a user operation input to the communication apparatus 101 and a content is to be played by the selected playing method. FIG. 4 is a flowchart illustrating a process to be implemented by a computer program stored in the storage unit 201 and read and executed by the control unit 202 when the communication apparatus 101 is instructed to perform content redirection.

At least a part of the processing in the flowchart in FIG. 4 may be implemented by hardware. In a case where at least a part of the flowchart is implemented by hardware, a predetermined compiler, for example, may be used to automatically generate dedicated circuits on an FPGA from the computer program implementing the operations. The processing may be implemented by hardware by forming Gate Array circuits in the same manner as that on the FPGA. The processing may be implemented by an ASIC.

This flowchart illustrates processing to be performed in S308 in FIG. 3 when a tap-and-hold operation performed by a user on a thumbnail of a content is received by the communication apparatus 101 in S308 in FIG. 3.

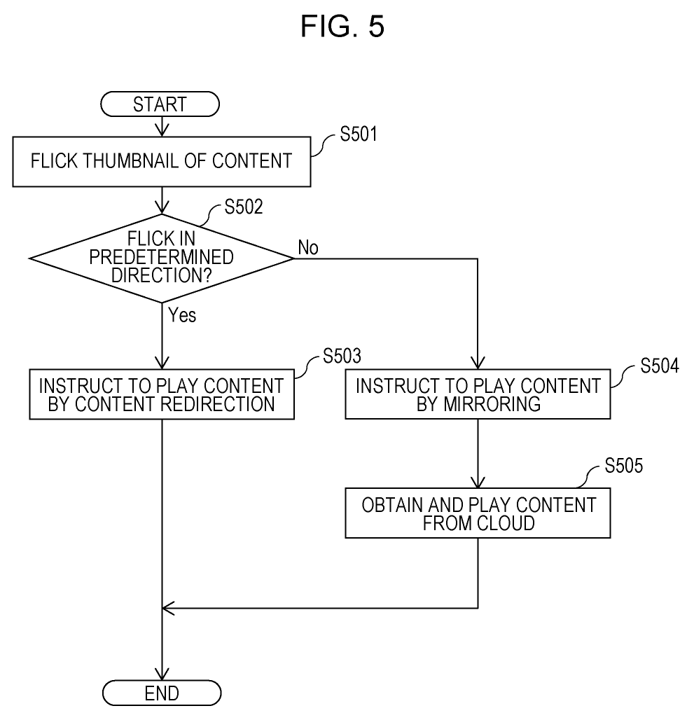

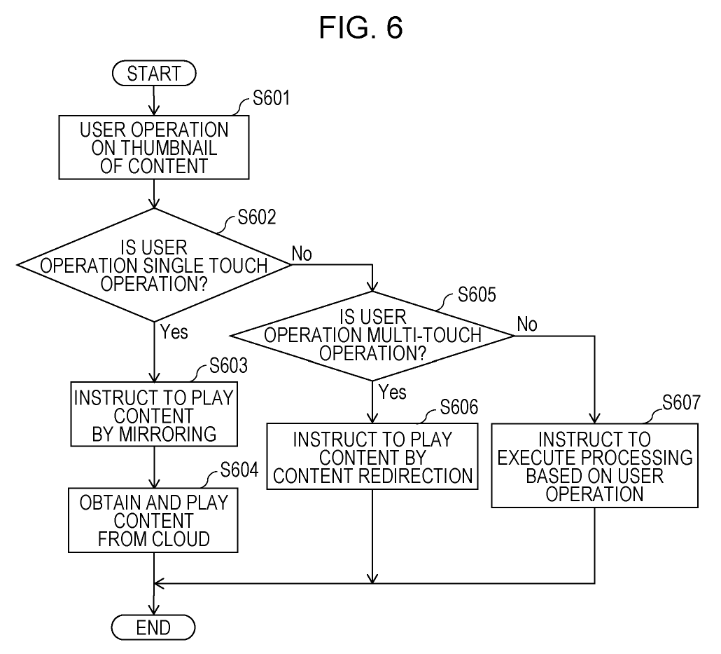

In S308 in FIG. 3, the communication apparatus 101 may perform a process in FIG. 5 or FIG. 6 instead of the process in FIG. 4. In response to a user operation performed on a thumbnail of a content, the communication apparatus 101 may perform at least one of the processes in FIG. 4 to FIG. 6. Alternatively, a combination of the plurality of processes in FIG. 4 to FIG. 6 may be performed, or the plurality of processes may be changed. Which process is to be performed by the communication apparatus 101 in S308 in FIG. 3 may be pre-set in the communication apparatus 101. Also, it may be determined by the application program to be used by the communication apparatus 101 for performing mirroring or by the application program to be used for performing content redirection. Also, it may be determined by a user.

First, the control unit 202 in the communication apparatus 101 receives an operation for tapping and holding a thumbnail of a content performed by a user through the input unit 204 (S401). The content in this operation can be played by both mirroring and content redirection.

Whether the subject tapped and held by a user is a thumbnail associated with a URI of the content may be determined based on information held in the storage unit 201 by the control unit 202 in the communication apparatus 101. The control unit 202 in the communication apparatus 101 determines whether the URI of the content is associated with the subject by using a pattern storage or HTTP based on the information held in the storage unit 201. The storage unit 201 in the communication apparatus 101 pre-stores in the pattern storage a pattern of URIs that users generally frequently access. Also, the pattern storage may pre-store a pattern of URIs of websites used very frequently by a user of the communication apparatus 101. In reading a hyperlink or an API for a website, the control unit 202 in the communication apparatus 101 may compare the information and the information stored in the storage unit 201 to determine whether the thumbnail is associated with the URI of the content. For the determination using HTTP, the storage unit 201 in the communication apparatus 101 may pre-store Content Types of HTTP Requests and values of HTTP Responses. In reading hyperlinked information, the control unit 202 in the communication apparatus 101 may compare it with the values stored in the storage unit 201 to determine whether the thumbnail is associated with the URI of the content.

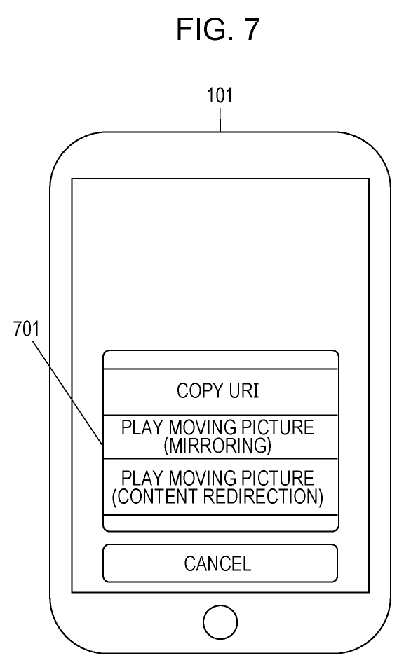

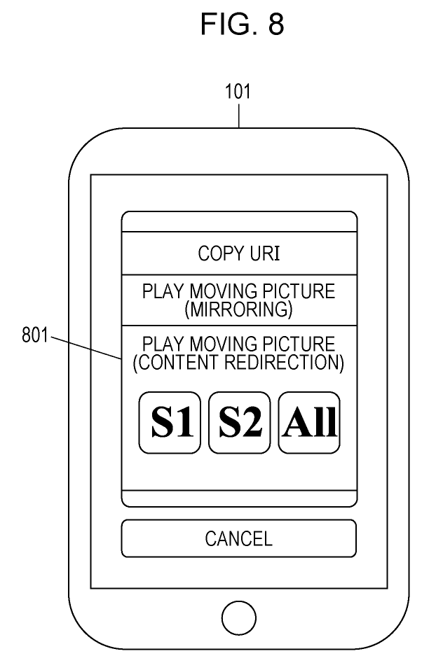

After S401, the control unit 202 in the communication apparatus 101, having received the operation for tapping and holding the thumbnail, displays a menu screen (S402). FIG. 7 and FIG. 8, which will be described below, illustrate examples of the menu screen to be displayed in this operation. The menu screen to be displayed in this operation is for prompting a user of the communication apparatus 101 to select whether the content is to be played by mirroring or content redirection. The control unit 202 in the communication apparatus 101 displays the menu screen to inquire of a user about whether the content is to be played by mirroring or content redirection.

FIG. 7 illustrates an example of a screen to be displayed by the communication apparatus 101 based on a user operation on the thumbnail of the content. The control unit 202 in the communication apparatus 101 displays a menu screen 701 through the output unit 205 in response to the tap-and-hold operation performed on the thumbnail of the content in S401. The menu screen 701 displays an option for playing the content by mirroring and an option for playing it by content redirection. In addition thereto, the menu screen 701 may display an option for performing processing based on a default function of an OS (Operating System) of the communication apparatus 101. According to this embodiment, the menu screen 701 further displays an option for copying the URI as a process based on the OS default function. However, some embodiments are not limited to these options. An option such as saving the URI or copying the URI as text may be displayed. The menu screen 701 may further display an option for performing a process based on a function inherent to an application program being used by the communication apparatus 101. The menu screen 701 may further display an option for returning to the last process before the communication apparatus 101 receives the operation for tapping and holding the thumbnail. FIG. 7 illustrates “Cancel” for the option. The control unit 202 in the communication apparatus 101 performs a process for executing a selected option based on a user operation for selecting one of the options by a user of the communication apparatus 101 through the input unit 204.

FIG. 8 illustrates an example of a screen to be displayed based on a user operation performed on a thumbnail of a content in a case where the communication apparatus 101 detects a plurality of communication apparatuses 102. The control unit 202 in the communication apparatus 101 displays a menu screen 801 through the output unit 205 based on a tap-and-hold operation performed on the thumbnail of the content in S401 and detection of a plurality of communication apparatuses 102 (sink apparatuses). The menu screen 801 is similar to the menu screen 701, but differences will be briefly described. The menu screen 801 displays a plurality of options for a sink apparatus to be a partner apparatus which plays the content by content redirection. Referring to FIG. 8, it is assumed here that the control unit 202 in the communication apparatus 101 is detecting two sink apparatuses. The menu screen 801 displays an option for performing content redirection with a first sink apparatus and an option for performing content redirection with a second sink apparatus. An option for performing content redirection with all of the detected sink apparatuses may additionally be displayed. In a case where both of a sink apparatus not connected with the communication apparatus 101 and a sink apparatus connected thereto are detected, the control unit 202 in the communication apparatus 101 may highlight the connected sink apparatus such that a user can recognize it. A partner apparatus with which the communication apparatus 101 is currently performing mirroring may be highlighted. According to this embodiment, the menu screen 801 displays the first sink apparatus and the second sink apparatus as S and S2, respectively. Embodiments are not limited thereto, but unique IDs, model names, or names set by a user of the sink apparatuses may be displayed. Based on a user operation performed for performing content redirection with one sink apparatus, the control unit 202 in the communication apparatus 101 performs processing for executing content redirection with the selected sink apparatus.

In a case where the communication apparatus 101 being a source apparatus is not connected with the sink apparatus selected as the partner apparatus with which the content redirection is to be performed, the communication apparatus 101 performs the processing in and subsequent to S304 in FIG. 3 on the selected sink apparatus so that they are connected. Then, the communication apparatus 101 starts playing the content by the content redirection with the selected sink apparatus. Alternatively, when a sink apparatus which is not connected to the communication apparatus 101 is selected as a partner apparatus for content redirection, the communication apparatus 101 may display an inquiry screen for inquiring of a user about whether content redirection with the selected sink apparatus is to be performed or not. If a user operation is performed on the inquiry screen and the user selects to perform content redirection with the sink apparatus, the communication apparatus 101 performs processing in and subsequent to S304 in FIG. 3 with the selected sink apparatus. The communication apparatus 101 then starts playing the content by the content redirection with the selected sink apparatus. On the other hand, if a user selects not to perform content redirection with the selected sink apparatus, the communication apparatus 101 displays the menu screen 801 again.

Referring to FIG. 8, if a user selects to play the content by mirroring, the control unit 202 in the communication apparatus 101 instructs to continue the mirroring with the sink apparatus which already has performed the mirroring with the communication apparatus 101 and to play the content.

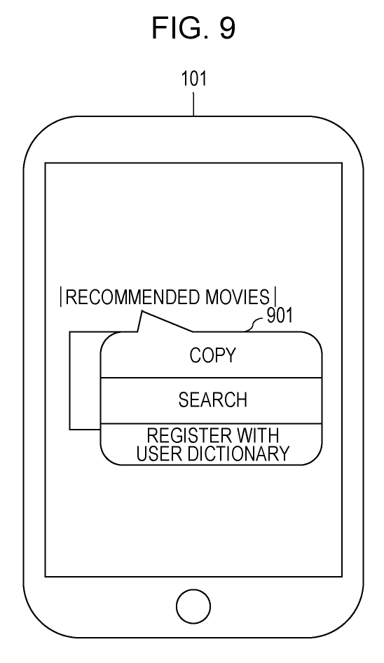

FIG. 9 illustrates an example of a screen to be displayed by the communication apparatus 101 based on a user operation performed on a representation not associated with the location information of the content. The control unit 202 in the communication apparatus 101 displays a menu screen 901 based on a tap-and-hold operation on a representation not associated with the location information of the content. The expression “representation not associated with the location information of the content” refers to a displayed image or character string not associated with a URI of the content. FIG. 9 illustrates an example of a menu to be displayed if a user taps and holds a description (text “RECOMMENDED MOVIES” in FIG. 9) as the representation not associated with the location information of the content. The menu screen 901 displays, as options, processes based on OS default functions of the communication apparatus 101. The menu screen 901 further displays, as an option, a process based on functions inherent to an application program utilized by the communication apparatus 101. The menu screen 901 displays, as options, “COPY”, “SEARCH”, “REGISTER WITH USER DICTIONARY” to be enabled for text that a user taps and holds. However, options to be displayed are not limited thereto.

The control unit 202 in the communication apparatus 101 can change the user interface (UI) to be displayed based on a subject on which a user performs a predetermined operation. The control unit 202 in the communication apparatus 101 may change the user interface to be displayed based on a subject of a user operation even when the communication apparatus 101 receives the same user operation from a user so that a user interface intended by the user can be displayed.

According to this embodiment, if a predetermined user operation is received on a representation associated with location information of a content, such as a content thumbnail, the control unit 202 in the communication apparatus 101 displays a menu screen as illustrated in FIG. 7 or FIG. 8. If a predetermined user operation is received on a display not associated with location information of a content, the control unit 202 in the communication apparatus 101 displays a menu screen as illustrated in FIG. 9. However, embodiments are not limited thereto, but in a case where mirroring with the communication apparatus 102 is being performed and a predetermined user operation is received on a representation associated with location information of a content, the control unit 202 in the communication apparatus 101 may display a menu screen as illustrated in FIG. 7 or FIG. 8. On the other hand, in a case where the communication apparatus 101 and the communication apparatus 102 are not performing mirroring, and even when a predetermined user operation is performed on a display associated with location information of a content, the control unit 202 in the communication apparatus 101 may display a menu screen as illustrated in FIG. 9.

When the menu screen is displayed in S402 in FIG. 4, the control unit 202 in the communication apparatus 101 may receive a user's selection on the menu screen that is displayed through the output unit 205 in S402 (S403). More specifically, in S403 the control unit 202 in the communication apparatus 101 receives a user operation on the menu screen that is displayed in S402 through the input unit 204.

The control unit 202 in the communication apparatus 101 determines whether a user selects playing the content by mirroring (S404). More specifically, whether the user operation received in S403 selects playing the content by mirroring. If it is determined that a user selects playing the content by mirroring (Yes in S404), the control unit 202 in the communication apparatus 101 performs processing in S405. On the other hand, if it is determined that a user does not select playing the content by mirroring (No in S404), the control unit 202 in the communication apparatus 101 performs the processing in S406.

Based on the location information of the content indicated by the URI associated with the thumbnail on which a tap-and-hold operation is performed, the control unit 202 in the communication apparatus 101 obtains the content from the cloud server 104 and starts playing the content (S405). The control unit 202 in the communication apparatus 101 having performed the processing in S405 ends the flow in the flowchart and performs the processing in S309 in FIG. 3. If a user instructs to play the content by mirroring, the control unit 202 in the communication apparatus 101 determines as No in S309 in FIG. 3 and continues to obtain and play the content in S310. The control unit 202 in the communication apparatus 101 performs the processing in S307 to continue the mirroring with the communication apparatus 102. If a user selects to play the content by mirroring, the communication apparatus 101 acting as the source apparatus obtains and plays the content and continues the mirroring with the communication apparatus 102 acting as the sink apparatus so that the content are also displayed on the communication apparatus 102.

On the other hand, if it is determined in S404 that a user does not select to play the content by mirroring, the control unit 202 in the communication apparatus 101 performs processing in S406. The control unit 202 in the communication apparatus 101 determines whether a user selects to play the content by content redirection (S406). More specifically, whether the user operation received in S403 is for selecting to play the content by content redirection is determined. If it is determined that a user selects to play the content by content redirection (Yes in S406), the flow in the flowchart ends. The processing in S309 in FIG. 3 is then performed. In this case, the control unit 202 in the communication apparatus 101 determines as Yes in S309 and performs the processing in and subsequent to S311 to start the play of the content by content redirection. In order to play a content by content redirection, the communication apparatus 101 being the source apparatus does not play the content. As a content redirection function of the communication apparatus 101 being the source apparatus, the communication apparatus 101 can transmit a play control signal for controlling play of the content being played in the sink apparatus to the sink apparatus. Then, the control unit 202 in the communication apparatus 101 may display a user interface for controlling the playing of a content based on Yes determined in S406.

On the other hand, if it is determined that a user does not select to play the content by content redirection (No in S406), the control unit 202 in the communication apparatus 101 ends the flow in the flowchart and performs the processing in S309 in FIG. 3. If a user instructs to perform a process other than playing a content by mirroring or content redirection in S403, the control unit 202 in the communication apparatus 101 determines as No in S403. The process selected in S403 may correspond to copying the URI displayed on the menu screen 701 in FIG. 7, for example. The process is not limited thereto, but may be a process based on another OS default function or a process based on a function inherent to an application program utilized by the communication apparatus 101. When the control unit 202 in the communication apparatus 101 ends the flow in the flowchart, No is determined in S309, and the processing in S310 is performed. In S310, the control unit 202 in the communication apparatus 101 performs the process selected by a user in S403 in FIG. 4. More specifically, if a user selects to copy the URI in S403 in FIG. 4, the control unit 202 in the communication apparatus 101 copies the URI in S310 in FIG. 3. After performing the process in S310, the control unit 202 in the communication apparatus 101 performs the processing in S307 and continues the mirroring.

According to this embodiment, because the communication apparatus 101 supports both playing methods of mirroring and content redirection, the communication apparatus 101 displays the menu screen on which both of the playing methods are selectable in S402. However, in a case where the communication apparatus 101 supports one of the playing methods, the communication apparatus 101 in S402 may display a menu screen on which the playing method is selectable. In this case, the communication apparatus 101 may not display or may gray out an option for a playing method that is not supported such that a user is disabled to select it. In S305 in FIG. 3, the communication apparatus 101 inquires about the content redirection function of the communication apparatus 102. If the communication apparatus 101 receives, from the communication apparatus 102, a notification that the communication apparatus 102 does not support the content redirection, the same kind of menu screen as described above may be displayed. According to this embodiment, the content can be played by both mirroring and content redirection. However, the same kind of menu screen may be displayed in a case where the content can be played by one of the playing methods. The display of the menu screen may vary based on the communication apparatus 101, the communication apparatus 102, or the playing method supported by a selected content so that a user can quickly grasp which playing method or methods is or are supported by the selected content.

Referring to FIG. 4, the control unit 202 in the communication apparatus 101 displays a menu screen in response to a predetermined operation performed on a thumbnail of a content in S401. However, embodiments are not limited thereto. The control unit 202 in the communication apparatus 101 may perform a process different from the menu screen display in a case where a user operation other than the predetermined operation is performed on a thumbnail of a content. For example, in a case where the predetermined operation is a tap-and-hold operation and when a touch operation is performed on a thumbnail of a content, the control unit 202 in the communication apparatus 101 may play the content by mirroring. Also, in that case, the control unit 202 in the communication apparatus 101 may play the content by content redirection, or the display is shifted to a webpage relating to the content. What kind of predetermined operation is to be performed by the control unit 202 in the communication apparatus 101 in a case where a user operation other than the predetermined operation is performed on the thumbnail of the content may be preset in the communication apparatus 101 or may be determined based on the OS in the communication apparatus 101. Also, it may be determined based on an application utilized by the communication apparatus 101 for performing mirroring.

The communication apparatus 101 in FIG. 4 enables a user to select whether a content is to be played by mirroring or content redirection on a menu screen displayed in response to a tap-and-hold operation performed on a thumbnail of a content. The menu screen display triggered by a user operation performed on a thumbnail of a content enables a user to intuitively perform operations thereon.

The menu screen display from which a content playing method is selectable based on a user operation on the content thumbnail may eliminate the necessity for the communication apparatus 101 to display different thumbnails corresponding to the playing methods.

Having described that the menu screen display is triggered by a tap-and-hold operation performed on a thumbnail, the communication apparatus 101, without limiting thereto, may be triggered to display the menu screen based on a double touch operation, a multi-touch operation, or a slide operation thereon. In a case where the communication apparatus 101 includes a sensor configured to detect a user operation for pressing in a touch panel corresponding to the input unit 204, a menu screen may be displayed based on the detection of such a press-in operation. Also, in a case where the communication apparatus 101 can be operated with a mouse, the communication apparatus 101 may be triggered to display a menu screen by a right-click operation, a click operation, or a double click operation performed on a thumbnail by the mouse.

FIG. 5 is a flowchart illustrating processing to be executed for playing a content by a playing method based on a user operation input to the communication apparatus 101. FIG. 5 may be implemented by a computer program stored in the storage unit 201 and read out and executed by the control unit 202 in order for the communication apparatus 101 to perform content redirection.

At least a part of the flowchart illustrated in FIG. 5 may be implemented by hardware. In a case where at least a part of the flowchart is implemented by hardware, a predetermined compiler, for example, may be used to automatically generate dedicated circuits on an FPGA from the computer program implementing the operations. The processing may be implemented by hardware by forming Gate Array circuits in the same manner as that on the FPGA. The processing may be implemented by an ASIC.

This flowchart illustrates processing to be performed in S308 in FIG. 3 in a case where the communication apparatus 101 receives a flick operation on a thumbnail of a content from a user in S308 in FIG. 3.

First, the control unit 202 in the communication apparatus 101 receives a flick operation on a thumbnail of a content from a user through the input unit 204 (S501). The content in this operation can be played by both mirroring and content redirection. Whether the subject of the flick operation performed by a user is a thumbnail associated with a URI of the content may be determined in the same manner as that in S401 in FIG. 4.

The control unit 202 in the communication apparatus 101 determines whether the flick operation received in S501 is a flick operation in a predetermined direction (S502). If it is determined that a user performs a flick operation in a predetermined direction (Yes in S502), the control unit 202 in the communication apparatus 101 performs processing in S503. On the other hand, if it is determined that a user does not perform a flick operation in the predetermined direction (No in S502), the control unit 202 in the communication apparatus 101 performs processing in S504. The case where “a user does not perform a flick operation in the predetermined direction” corresponds to a case where the user performs a flick operation in a direction other than the predetermined direction. The predetermined direction is defined by an application program utilized for performing mirroring or content redirection by the communication apparatus 101. Also, it may be preset in the communication apparatus 101 or may be defined by a user.

Based on the flick operation in the predetermined direction, the control unit 202 in the communication apparatus 101 determines that the user has instructed to play the content by content redirection (S503). After performing the processing in S503, the control unit 202 in the communication apparatus 101 ends the flow in the flowchart and performs the processing in S309 in FIG. 3. In this case, the control unit 202 in the communication apparatus 101 determines as Yes in S309 and starts playing the content by content redirection.

Based on a flick operation performed in a direction toward the communication apparatus 102 being the sink apparatus as the predetermined direction on the thumbnail of the content, the control unit 202 in the communication apparatus 101 may play the content by content redirection. The control unit 202 in the communication apparatus 101 may acquire positional information of the sink apparatus by using a GPS or the Wi-Fi location standard. When the communication apparatus 101 being the source apparatus is connected to a plurality of sink apparatuses, the communication apparatus 101 acquires positional information of the sink apparatuses. In this case, based on a performed flick operation in a predetermined direction or in a direction toward a certain one of the sink apparatuses, the control unit 202 in the communication apparatus 101 determines that content play by content redirection with the sink apparatus is selected.

In playing a content by content redirection, the communication apparatus 101 being the source apparatus does not play the content. The communication apparatus 101 may have the content redirection function as the source apparatus including transmission of a play control signal for controlling play of a content while being played in the sink apparatus from the communication apparatus 101 to the sink apparatus. Based on Yes determined in S406, the control unit 202 in the communication apparatus 101 may display a user interface for controlling play of the content.

On the other hand, if it is determined that a user does not perform a flick operation in the predetermined direction (No in S502), the control unit 202 in the communication apparatus 101 determines that content play by mirroring is instructed (S504).

Based on the location information of a content indicated by the URI associated with the thumbnail on which the flick operation has been performed, the control unit 202 in the communication apparatus 101 obtains the content from the cloud server 104 and starts playing the content (S505). The following processing is the same as the processing after S405 in FIG. 4.

Based on a putting a finger on a thumbnail of a content by a user through the input unit 204, the control unit 202 in the communication apparatus 101 may display an operation menu displaying a correspondence relationship between flick operation directions and processes to be selected. A user can conveniently quickly grasp from the displayed operation menu the direction in which the user needs to flick to play a content by a desired playing method. When the user releases his or her finger from the input unit 204, the control unit 202 in the communication apparatus 101 may hide the operation menu.

Referring to FIG. 5, the communication apparatus 101 determines a content playing method based on a flick operation in a predetermined direction on a thumbnail of a content so that the content can be played by the playing method desired by the user. A content can be played by a predetermined playing method based on a flick operation in a predetermined direction performed by a user, which means that the desired playing method can be selected by a user's intuitive operation.

The selection of a content playing method based on the type of user operation can eliminate necessity for the communication apparatus 101 to display different thumbnails corresponding to playing methods.

When a flick operation in a direction other than a predetermined direction is received, it has been described above that the communication apparatus 101 performs content play by mirroring. However, some embodiments are not limited thereto. When a flick operation in a direction other than a predetermined direction is received, the communication apparatus 101 may not perform a special process. More specifically, if the control unit 202 in the communication apparatus 101 determines as No in S502, the flow in the flowchart ends, and the processing in S309 in FIG. 3 is performed. The control unit 202 in the communication apparatus 101 determines as No in S309 and performs processing in S310. In this case, the control unit 202 in the communication apparatus 101 does not perform a special process in S310 but performs processing in S307, and the mirroring is continued. Alternatively, when a flick operation in a direction other than a predetermined direction is received, the communication apparatus 101 may scroll the screen. For example, a flick operation in a direction other than a predetermined direction may be determined as a flick operation toward the bottom. The control unit 202 in the communication apparatus 101 determines as No in S502, and the flow in the flowchart of FIG. 5 ends. Then, the processing in S309 in FIG. 3 is performed. The control unit 202 in the communication apparatus 101 determines as No in S309 and performs the processing in S310. In this case, the control unit 202 in the communication apparatus 101 scrolls the screen toward the bottom in S310. Then, the processing in S307 is performed to continue the mirroring.

According to the flowchart, a playing method is selected based on a flick operation performed by a user on the communication apparatus 101 including a touch panel as the input unit 204, such as a smart phone. However, some embodiments are not limited thereto, but the communication apparatus 101 may select a playing method based on a user operation involving a finger movement operation in a predetermined direction, such as a slide operation or a swipe operation performed by a user. The communication apparatus 101 may select a playing method based on a mouse operation, such as a right click operation, a click operation, a double click operation, a drag operation, or a drop operation.

FIG. 6 is another flowchart illustrating processing to be executed for playing a content by a playing method based on a user operation input to the communication apparatus 101. FIG. 6 is a flowchart illustrating process to be implemented by a computer program stored in the storage unit 201 and read and executed by the control unit 202 when the communication apparatus 101 is instructed to perform content redirection.

At least a part of the processing in the flowchart in FIG. 6 may be implemented by hardware. In a case where at least a part of the flowchart is implemented by hardware, a predetermined compiler, for example, may be used to automatically generate dedicated circuits on an FPGA from the computer program implementing the operations. The processing may be implemented by hardware by forming Gate Array circuits in the same manner as that on the FPGA. The processing may be implemented by an ASIC.

This flowchart illustrates the processing to be performed in S308 in FIG. 3 when a user operation, such as a touch operation performed on a thumbnail of a content, is received by the communication apparatus 101 in S308 in FIG. 3.

First, the control unit 202 in the communication apparatus 101 receives a user operation on a thumbnail of a content performed by a user through the input unit 204 (S601). The content in this operation can be played by both mirroring and content redirection. Whether the subject receiving a user operation is a thumbnail associated with a URI of the content may be determined in the same manner as that in S401 in FIG. 4.

The control unit 202 in the communication apparatus 101 determines whether the user operation that was received in S601 is a single-touch operation (S602). The single-touch operation is a touch operation performed by a user of the communication apparatus 101 by using one finger. If the control unit 202 in the communication apparatus 101 determines that the user operation received in S601 is the single-touch operation (Yes in S602), processing in S603 is performed. The control unit 202 in the communication apparatus 101 determines that it is instructed by a user to play the content by mirroring based on the touch operation received as a user operation (S603). After performing the processing in S603, the communication apparatus 101 performs processing in S604. In this case, the processing in S604 is performed in the same manner as that in S405 in FIG. 4.

On the other hand, if the control unit 202 in the communication apparatus 101 determines that the user operation received in S601 is not the single-touch operation (No in S602), the control unit 202 performs processing in S605. The control unit 202 in the communication apparatus 101 determines whether the user operation received in S601 is a multi-touch operation (S605). The multi-touch operation is a touch operation to be performed by a user of the communication apparatus 101 by using two or more fingers simultaneously. If the control unit 202 in the communication apparatus 101 determines that the multi-touch operation is received in S601 (Yes in S605), the processing in S606 is performed. The control unit 202 in the communication apparatus 101 determines that it is instructed by a user to play the content by content redirection based on the received multi-touch operation (S606).

On the other hand, if the control unit 202 in the communication apparatus 101 determines that the multi-touch operation is not received in S605 (No in S605), processing in S607 is performed. The control unit 202 in the communication apparatus 101 determines it was instructed to perform a process other than play of the content by mirroring or content redirection in S605 (S607). The control unit 202 in the communication apparatus 101 determines a process to be performed based on the received user operation in accordance with the OS in the communication apparatus 101. Additionally or alternatively, the determination may be made based on an application utilized by the communication apparatus 101. After the processing in S607 is performed, the control unit 202 in the communication apparatus 101 ends the flow in the flowchart in FIG. 6 and performs the processing in S309 in FIG. 3. In this case, the control unit 202 in the communication apparatus 101 determines as No in S309 and performs the processing in S310. In S310, the control unit 202 in the communication apparatus 101 performs a process based on the user operation received in S601 in FIG. 6.

In this flowchart, the control unit 202 in the communication apparatus 101 determines a content playing method based on the type of user operation received on the thumbnail of the content. More specifically, the control unit 202 in the communication apparatus 101 plays a content by mirroring if a single-touch operation is received while playing the content by content redirection if a multi-touch operation is received. However, the control unit 202 in the communication apparatus 101 may select to play a content by mirroring if a double-touch operation, a tap-and-hold operation, a slide operation, or a swipe operation is received on the thumbnail of the content. Also, the control unit 202 in the communication apparatus 101 may select to play a content by mirroring based on a drag operation and a drop operation performed on the thumbnail of the content to a predetermined region on a screen. The control unit 202 in the communication apparatus 101 may select to play a content by content redirection based on other user operations in the same manner. Also, in a case where the communication apparatus 101 can detect that a press-in operation is performed on a touch panel being the input unit 204, the control unit 202 in the communication apparatus 101 may select to play a content by mirroring based on a detection of the press-in operation. Also, if a press-in operation is received as a user operation, the control unit 202 in the communication apparatus 101 may select to play a content by content redirection. Also, the control unit 202 in the communication apparatus 101 may select to play a content by content redirection or mirroring in accordance with the strength of the received press-in operation. For example, if a press-in operation with a predetermined strength or higher is received, the control unit 202 in the communication apparatus 101 may select to play a content by content redirection. In this case, if a press-in operation weaker than the press-in operation is received, the control unit 202 in the communication apparatus 101 selects to play a content by mirroring.

Referring to FIG. 6, the control unit 202 in the communication apparatus 101 selects whether a content is to be played by mirroring or content redirection based on the received type of user operation. Such a menu screen display triggered by a user operation performed on a thumbnail of a content enables a user to intuitively operate the apparatus.

Selection of a content playing method based on the type of user operation may eliminate the necessity for the communication apparatus 101 to display different thumbnails corresponding to different playing methods.

In this flowchart, a playing method is selected based on the type of user operation on the communication apparatus 101, such as a smart phone, including a touch panel as the input unit 204. However, embodiments are not limited thereto, but the communication apparatus 101 may select a playing method based on the type of user operation, such as mouse operations including a right-click operation, a click operation, a double-click operation, a drag operation, and a drop operation.

In some embodiments, the communication apparatus 101 may support the playing method selection based on at least one flowchart of FIG. 4, FIG. 5, and FIG. 6.

According to this embodiment, the control unit 202 in the communication apparatus 101 selects a content playing method based on an input user operation. Embodiments are not limited thereto, but the control unit 202 in the communication apparatus 102 may select a content playing method. In this case, the control unit 202 in the communication apparatus 102 may select a content playing method based on a user operation input through the input unit 204 in the communication apparatus 102.

According to this embodiment, the control unit 202 in the communication apparatus 101 determines whether a content is to be played by mirroring or by content redirection. When a content is played by mirroring, the traffic of the communication apparatus 102 being the sink apparatus can be reduced. When an upper limit is set for the traffic of the communication utilized by the communication apparatus 102, the traffic can be prevented from reaching the upper limit. In a case where the communication utilized by the communication apparatus 102 is on a pay-as-you-go-basis, a user can prevent an increase of communication charges. In a case where a content is to be played by content redirection, a user may be required to wait for completion of start-up processing of an application for playing the content in the communication apparatus 102 before the content start to play. Playing a content by mirroring may eliminate a user's wait for the time for the start-up processing of content redirection. In a case where the communication apparatus 101 being the source apparatus is a communication apparatus, such as a computer, which can simultaneously display a plurality of screens, playing a content by mirroring enables the communication apparatus 102 being the sink apparatus to simultaneously display a plurality of screens. More specifically, for example, in a case where the communication apparatus 101 simultaneously displays a content and a document file, the content may be played by mirroring so that the communication apparatus 102 can also simultaneously display the content and the document file. Thus, a user can simultaneously share the content and the document file.

On the other hand, when a content is played by content redirection, the traffic of the communication apparatus 101 being the source apparatus can be reduced. When an upper limit is set for the traffic of the communication utilized by the communication apparatus 101, the traffic can be prevented from reaching the upper limit. In a case where the communication utilized by the communication apparatus 101 is on a pay-as-you-go-basis, a user can prevent an increase of communication charges. In a case where a content is played by content redirection, a screen displayed by the communication apparatus 101 is not shared with the communication apparatus 102 being the sink apparatus. Thus, a user can perform a process other than playing a content by using the communication apparatus 101. For example, the user can browse the Internet or create an e-mail by using the communication apparatus 101, resulting in improved user's convenience. In a case where the communication apparatus 101 plays a content by mirroring, the communication apparatus obtains the content from the cloud server 104 and plays the obtained content. Through the mirroring process, the content can be displayed on the monitor screen of the communication apparatus 102 being the sink apparatus. On the other hand, in a case where a content is played by content redirection, the communication apparatus 101 does not play the content, resulting in a reduced load imposed on the communication apparatus 101 and reduced power consumption of the communication apparatus 101.

According to this embodiment, the communication apparatus 101 selects whether a content is to be played by mirroring or content redirection based on a user operation performed on a thumbnail of the content. However, instead of or in addition to content redirection, the communication apparatus 101 can selects to play a content by direct streaming based on a user operation. In this case, the URI associated with the thumbnail of the content indicates a location of the content in the communication apparatus 101.

In a case where the communication apparatus 101 is a communication apparatus which is capable of playing a content by direct streaming, the control unit 202 in the communication apparatus 101 determines whether it is instructed to play a content by direct streaming, instead of the processing in S309 in FIG. 3.

It is assumed here that the communication apparatus 101 is a communication apparatus capable of playing a content by one of mirroring, direct streaming, and content redirection. In this case, the communication apparatus 101 determines whether it is instructed to play a content by direct streaming in parallel with the processing in S309 in FIG. 3. Also, if No is determined in S309, whether it is instructed to play a content by direct streaming can be determined before the processing in S310. If the control unit 202 in the communication apparatus 101 determines that it is not instructed to play a content by direct streaming, the processing in S310 is performed.

On the other hand, if the control unit 202 in the communication apparatus 101 determines that it is instructed to play a content by direct streaming, the control unit 202 inquires the communication apparatus 102 about whether the communication apparatus 102 supports direct streaming for content play. In response to the inquiry about whether the communication apparatus 102 supports direct streaming from the communication apparatus 101, the control unit 202 in the communication apparatus 102 transmits a response indicating whether the communication apparatus 102 supports direct streaming for content play. Based on the response received from the communication apparatus 102 and if the communication apparatus 102 does not support direct streaming, the control unit 202 in the communication apparatus 101 starts playing the content, and the processing in S307 is performed. In other words, if the communication apparatus 102 does not support direct streaming, the communication apparatus 101 plays the content and continues mirroring with the communication apparatus 102. Also, if the communication apparatus 102 does not support direct streaming, the control unit 202 in the communication apparatus 101 may not start playing the content and may notify a user of that the communication apparatus 102 does not support direct streaming. After notifying that the communication apparatus 102 does not support direct streaming, the control unit 202 in the communication apparatus 101 may perform the processing in S307. On the other hand, if the communication apparatus 102 supports direct streaming, the control unit 202 in the communication apparatus 101 determines a monitor screen, the type of audio encoding scheme, and video resolution and frame rate to be used for the direct streaming with the communication apparatus 102. In S305 and S353 in FIG. 3, the communication apparatus 101 and the communication apparatus 102 may check whether the communication apparatus 102 supports direct streaming. The communication apparatus 101 and the communication apparatus 102 may previously determine an encoding scheme to be used for direct streaming.

The control unit 202 in the communication apparatus 101 may transmit a content to the communication apparatus 102. In this case, the communication apparatus 101 may not play the content. The communication apparatus 101 and the communication apparatus 102 temporarily stop the mirroring during play of a content by direct streaming. More specifically, the communication apparatus 101 and the communication apparatus 102 perform the same processing as that in S314 and S358 in FIG. 3 to temporarily stop the mirroring. After receiving a content from the communication apparatus 101, the control unit 202 in the communication apparatus 102 plays the received content. When the communication apparatus 102 starts playing the received content, the communication apparatus 101 and the communication apparatus 102 perform the same processing as that in S315 and S360 in FIG. 3.

According to this embodiment, the communication apparatus 101 handles the same communication apparatus 102 as a sink apparatus for playing a content by mirroring and by content redirection. Embodiments are not limited thereto, but different communication apparatuses may be handled as sink apparatuses in accordance with the playing methods. More specifically, the communication apparatus 101 may handle the communication apparatus 102 as a sink apparatus for playing a content by mirroring and may handle a communication apparatus different from the communication apparatus 102 as a sink apparatus for playing a content by content redirection.

The control unit 202 in the communication apparatus 101 plays a content by mirroring or content redirection based on a user operation performed on a thumbnail of a content. Alternatively, the control unit 202 in the communication apparatus 101 may play a content by direct streaming instead of or in addition to the content redirection. In addition to them, the control unit 202 in the communication apparatus 101 may play a content on the communication apparatus 101 based on a user operation received before the mirroring processing (S307 in FIG. 3) starts. In this case, the communication apparatus 101 skips the processing in S307 and does not perform mirroring.

According to this embodiment, if the communication apparatus 101 receives a multi-touch operation, the control unit 202 in the communication apparatus 101 performs processing, such as selecting a content playing method, irrespective of the number of fingers having performed the touch operation. However, embodiments are not limited thereto, but, if a multi-touch operation is performed, the communication apparatus 101 may change the process to be performed based on the number of fingers used for the multi-touch operation. For example, the control unit 202 in the communication apparatus 101 may select mirroring if a multi-touch operation by two fingers is received, and may select content redirection if a multi-touch operation by three fingers is received.

According to this embodiment, if the control unit 202 in the communication apparatus 101 receives a predetermined user operation on a thumbnail of a content, the control unit 202 displays a menu screen and prompts a user to select whether the content is to be played by mirroring or content redirection. The control unit 202 in the communication apparatus 101 plays the content by mirroring or content redirection based on a user selection performed on the displayed menu screen. In this case, the control unit 202 in the communication apparatus 101 selects whether the content is played by mirroring or by content redirection before a link destination of location information associated with the thumbnail of the content is displayed. The content is displayed at the link destination of the location information. For example, the link destination of the URL associated with the thumbnail of the content may be a page for playing the content within a moving image service providing a content. In a case where the content includes image data, the play page may display the image data included in the content, the title of the content, and a GUI for playing the content. The control unit 202 in the communication apparatus 101, in response to a predetermined user operation performed on the thumbnail of a content, displays a menu screen before displaying the play page of the content to prompt a user to select whether the content is to be played by mirroring or content redirection. The control unit 202 in the communication apparatus 101 then starts playing the content by the playing method selected by the user.

For example, when the communication apparatus 101 displays a play page for a content, it may sometimes be set such that the communication apparatus 101 obtains and buffers a part of the content. Prompting a user to select a content playing method before the control unit 202 in the communication apparatus 101 displays the play page for such a content can eliminate the performance of unnecessary buffering by the communication apparatus 101. For example, in order to play a content by content redirection, the communication apparatus 102 actually obtains the content. Therefore, the communication apparatus 101 may not buffer the content. Accordingly, the control unit 202 in the communication apparatus 101 prompts a user to select a content playing method before a content play page is displayed so that unnecessary buffering may not be performed when the user selects to play the content by content redirection.

According to this embodiment, the same is also true in the case where the control unit 202 in the communication apparatus 101 selects a content playing method based on the type of user operation received on a thumbnail of a content. The control unit 202 in the communication apparatus 101 selects a content playing method based on a user operation performed on a thumbnail of a content before a play page is displayed. When a user performs a user operation to instruct to play a content by content redirection on the thumbnail, the communication apparatus 101 may not perform unnecessary buffering. The same is true in the case where the control unit 202 in the communication apparatus 101 selects a content playing method based on the type and direction of the user operation received on a thumbnail of a content.

At least a part or all of the processing by the communication apparatus 101 and the communication apparatus 102 illustrated in the flowcharts in FIG. 3 to FIG. 6 may be implemented by hardware. In a case where at least a part of the flowchart is implemented by hardware, a predetermined compiler, for example, may be used to generate and use dedicated circuits on an FPGA from the computer program implementing the operations. The processing may be implemented by hardware by forming Gate Array circuits in the same manner as that on the FPGA. The processing may be implemented by an ASIC.

The operations in the flowcharts illustrated in FIG. 3 to FIG. 6 may be distributed in a plurality of CPUs or apparatuses. When the operations are distributed in a plurality of apparatuses, the source apparatus operates as a source system, and the sink apparatus operates as a sink system.

Having described embodiments in detail above, the present disclosure can be embodied as, for example, a system, an apparatus, a method, a program or a recording medium (computer readable storage medium) or the like. More specifically, embodiments are applicable to a system including plurality of apparatuses (such as a host computer, an interface apparatus, an imaging apparatus, and a web application) or may be applied to an apparatus including one device.

The present disclosure may be implemented by a program implementing one or more functions of the aforementioned embodiments, which is supplied to a system or an apparatus over a network or through a computer readable storage medium and is read and executed by one or more processors in a computer in the system or the apparatus. The present disclosure may be implemented by a circuit (such as an ASIC) implementing one or more functions.

### Other Embodiments

Some embodiment(s) can also be realized by a computer of a system or apparatus that reads out and executes computer-executable instructions (e.g., one or more programs) recorded on a storage medium (which may also be referred to more fully as a ‘non-transitory computer-readable storage medium’) to perform the functions of one or more of the above-described embodiment(s) and/or that includes one or more circuits (e.g., ASIC) for performing the functions of one or more of the above-described embodiment(s), and by a method performed by the computer of the system or apparatus by, for example, reading out and executing the computer-executable instructions from the storage medium to perform the functions of one or more of the above-described embodiment(s) and/or controlling the one or more circuits to perform the functions of one or more of the above-described embodiment(s). The computer may comprise one or more processors (e.g., central processing unit (CPU), micro processing unit (MPU)) and may include a network of separate computers or separate processors to read out and execute the computer-executable instructions. The computer-executable instructions may be provided to the computer, for example, from a network or the storage medium. The storage medium may include, for example, one or more of a hard disk, a random-access memory (RAM), a read only memory (ROM), a storage of distributed computing systems, an optical disk (such as a compact disc (CD), digital versatile disc (DVD), or Blu-ray Disc (BD)™), a flash memory device, a memory card, and the like.

The present disclosure can provide a communication apparatus which can play a content by a playing method based on a user operation.

While the present disclosure has described exemplary embodiments, it is to be understood that the claims is not limited to the disclosed exemplary embodiments. The scope of the following claims is to be accorded the broadest interpretation so as to encompass all such modifications and equivalent structures and functions.

This application claims priority to Japanese Patent Application No. 2018-042445, which was filed on Mar. 8, 2018 and which is hereby incorporated by reference herein in its entirety.

What is claimed is:

1. A communication apparatus comprising:
a playing unit configured to play a content;
a first transmitting unit configured to transmit at least one of image data based on a screen displayed by the communication apparatus and audio data based on audio played by the communication apparatus;
a second transmitting unit configured to transmit location information of the content or the content to a first other communication apparatus for causing the first other communication apparatus to play the content;
a display unit configured to display an association representation associated with the location information;
a receiving unit configured to receive a user operation relating to the association representation displayed by the display unit; and
a selecting unit configured to, in a case where the receiving unit receives the user operation relating to the association representation, select whether the playing the content by the playing unit and the transmission by the first transmitting unit or the transmission by the second transmitting unit based on the user operation before the content is displayed.

2. The communication apparatus according to claim 1, further comprising:
an inquiry unit configured to inquire of a user about whether the playing the content by the playing unit and the transmission by the first transmitting unit or the transmission by the second transmitting unit before the content is displayed,
wherein the selecting unit selects whether the playing the content by the playing unit and the transmission by the first transmitting unit are to be performed or the transmission by the second transmitting unit is to be performed based on a response received as the user operation from a user to the inquiry.

3. The communication apparatus according to claim 1, wherein the selecting unit selects whether the playing the content by the playing unit and the transmission by the first transmitting unit are to be performed or the transmission by the second transmitting unit is to be performed based on a type of the user operation.

4. The communication apparatus according to claim 1, wherein the user operation is one of a single-touch operation, a double-touch operation, a multi-touch operation, a tap-and-hold operation, a flick operation, a drag operation, and a press-in operation.

5. The communication apparatus according to claim 1, wherein the user operation is one of a click operation, a double-click operation, a right-click operation, and a drag operation.

6. The communication apparatus according to claim 1, wherein, in a case where the user operation is a user operation involving a finger movement operation in a predetermined direction, the selecting unit selects whether the playing the content by the playing unit and the transmission by the first transmitting unit are to be performed or the transmission by the second transmitting unit based on the predetermined direction is to be performed.

7. The communication apparatus according to claim 6, wherein, based on a fact that the user operation is a user operation involving a finger movement operation in a first predetermined direction, the selecting unit selects to perform the playing the content by the playing unit and the transmission by the first transmitting unit, and, based on a fact that the user operation is a user operation involving a finger movement operation in a second predetermined direction, selects to perform the transmission by the second transmitting unit.

8. The communication apparatus according to claim 7, further comprising:
an obtaining unit configured to obtain positional information of the first other communication apparatus with respect to the communication apparatus,
wherein the second predetermined direction is a direction based on the positional information obtained by the obtaining unit.

9. The communication apparatus according to claim 6, wherein the user operation is one of a flick operation, a swipe operation, and a slide operation.

10. The communication apparatus according to claim 1, wherein the association representation is a character string or an image.

11. The communication apparatus according to claim 10, wherein the association representation is a hyperlink to the content.

12. The communication apparatus according to claim 10, wherein the association representation is a thumbnail of the content.

13. The communication apparatus according to claim 10, wherein the association representation is a play button for the content.

14. The communication apparatus according to claim 1, further comprising:
a processing unit configured to perform a process different from the transmission by the first transmitting unit and the transmission by the second transmitting unit,
wherein, in a case where the receiving unit receives the user operation relating to the association representation, the selecting unit selects whether the playing the content by the playing unit and the transmission by the first transmitting unit are to be performed, the transmission by the second transmitting unit is to be performed, or the process by the processing unit is to be performed based on the user operation before the content is displayed.

15. The communication apparatus according to claim 14, wherein the processing unit performs a process based on a default function of an OS (Operating System) running on the communication apparatus.

16. The communication apparatus according to claim 14, wherein the processing unit performs a process based on a function inherent to an application utilized by the communication apparatus.

17. The communication apparatus according to claim 1, wherein the first transmitting unit transmits at least one of the image data and the audio data to the first other communication apparatus.

18. The communication apparatus according to claim 1, wherein the first transmitting unit transmits at least one of the image data and the audio data to a second other communication apparatus different from the first other communication apparatus.

19. The communication apparatus according to claim 1,
wherein, in a case where the communication apparatus holds the content,
the second transmitting unit transmits the content to the first other communication apparatus, and
wherein the location information is information indicating a location of the content in the communication apparatus.

20. The communication apparatus according to claim 1,
wherein, in a case where an external apparatus holds the content,
the second transmitting unit transmits the location information to the first other communication apparatus, and
wherein the location information is information indicating a location of the content in the external apparatus.

21. The communication apparatus according to claim 1, wherein the communication apparatus performs the transmission of at least one of the image data and the audio data by the first transmitting unit based on the Wi-Fi Miracast standard.

22. The communication apparatus according to claim 1, wherein the communication apparatus performs the transmission by the second transmitting unit based on the Wi-Fi Miracast standard.

23. A communication method comprising:
displaying an association representation associated with location information regarding a content;
receiving a user operation relating to the association representation displayed by the displaying; and
in a case where the receiving receives the user operation, before the content is displayed, selecting, based on a user operation, whether a first communication apparatus performs playing the content and transmission of at least one of image data based on a screen displayed by the first communication apparatus and audio data based on audio played by the first communication apparatus or, in order to cause a second communication apparatus to play the content, the location information or the content is transmitted to the second communication apparatus.

24. A computer-readable recording medium recording a program causing a computer to function as units of a communication apparatus, the program comprising:
displaying an association representation associated with location information regarding a content;
receiving a user operation relating to the association representation displayed by the displaying; and
in a case where the receiving receives the user operation, before the content is displayed, selecting, based on a user operation, whether a first communication apparatus performs playing the content and transmission of at least one of image data based on a screen displayed by the first communication apparatus and audio data based on audio played by the first communication apparatus or, in order to cause a second communication apparatus to play the content, the location information or the content is or are transmitted to the second communication apparatus.
